(19) United States
(12) Patent Application Publication
(10) Pub. No.: US 2025/0212020 A1
(43) Pub. Date: Jun. 26, 2025

(54) DYNAMICALLY PROVISIONING AND MANAGING NETWORK COMMUNICATIONS USING A SEGMENTED NETWORK ARCHITECTURE

(71) Applicant: VIASAT, INC., Carlsbad, CA (US)

(72) Inventors: Michael S. Foxworthy, Vista, CA (US); Gurjot S. Chadda, Burtonsville, MD (US)

(73) Assignee: VIASAT, INC., Carlsbad, CA (US)

(21) Appl. No.: 18/844,913

(22) PCT Filed: Mar. 7, 2022
(86) PCT No.: PCT/US2022/019179

§ 371 Date: Sep. 6, 2024

(51) Int. Cl. H04W 24/02; H04B 17/318; H04W 60/00; H04W 84/12

(52) U.S. Cl. CPC H04W 24/02; H04B 17/328; H04W 60/00; H04W 84/12

(57) ABSTRACT

Described herein are systems and methods for dynamically provisioning network communications systems that use a segmented network architecture to provide wireless access to a satellite network to ultimately provide connectivity to an external network such as the Internet. The disclosed technologies enable dynamic and automated provisioning of network infrastructure that provides wireless access over a geographic area. The disclosed technologies also enable self-healing network nodes, or network nodes that can automatically reconfigure themselves to maintain network connectivity in the case that another network node ceases to function properly. Advantageously, this allows the disclosed network communications systems to be deployed, installed, and maintained by relatively unskilled operators or technicians. This may be particularly beneficial in remote communities where there is a lack of skilled network engineers.

### BACKGROUND

### Field

The present disclosure generally relates to provisioning a network communications system.

### Description of Related Art

Network communications systems require infrastructure to communicatively couple devices to each other and to other components, such as routers, servers, and gateways. In rural or remote areas, it may be challenging to provide wired access for network communication. It may also be difficult to provide cellular service to remote areas. Consequently, people living in rural or remote areas may find it difficult or impossible to access external networks such as the Internet. To address these challenges, satellites can be used to provide Internet connectivity to users in these remote areas. An example of a communication channel selection method is provided in U.S. Pat. Pub. No. 2021/0377915 to Lalam et al. An example of layer two network tunnels for Wi-Fi client bridging in a distributed Wi-Fi network is provided in U.S. Pat. Pub. No. 2017/0272273 to Singla et al. An example of a wireless communication method used in wireless communication device and wireless communication device is provided in U.S. Pat. Pub. No. 2022/0060979 to Chung et al. An example of a method for associating a new gathering node in a distributed wireless network is provided in U.S. Pat. Pub. No. 20210289574 to Raby et al.

### SUMMARY

According to a number of implementations, the present disclosure relates to a network communications system that includes a level zero node comprising a network controller and configured to connect to an external network. The network communications system also includes a level one node configured to wirelessly communicate with the level zero node using a first wireless local area network (WLAN) frequency band, to provide a first subscriber access point to enable one or more client devices to communicate with the external network, and to advertise a subscriber service set identifier (SSID) for connecting to the first subscriber access point, the first subscriber access point using a second WLAN frequency band different from the first WLAN frequency band. The network communications system also includes a level two node configured to wirelessly communicate with the level one node using the first WLAN frequency band, to provide a second subscriber access point to enable one or more client devices to communicate with the external network, and to advertise the subscriber SSID for connecting to the second subscriber access point, the second subscriber access point using the second WLAN frequency band. The level one node is configured to provide a first subscriber tunnel to tunnel network traffic to the level zero node using the first WLAN frequency band and the level two node is configured to provide a second subscriber tunnel to tunnel network traffic to the level zero node by traversing the level one node using the first WLAN frequency band.

In further embodiments, the first subscriber tunnel and the second subscriber tunnel are provisioned dynamically.

In some embodiments, the level zero node is configured to communicate with a satellite network to connect to the external network. In some embodiments, the external network comprises the Internet. In some embodiments, the first WLAN frequency band comprises the 5 GHz frequency band and the second WLAN frequency band comprises the 2.4 GHz frequency band.

In some embodiments, the level zero node is further configured to advertise a backhaul SSID to provide a first backhaul access point that uses the first WLAN frequency band. In further embodiments, the level one node is configured to connect to the first backhaul access point provided by the level zero node and to advertise the backhaul SSID to provide a second backhaul access point that uses the first WLAN frequency band. In yet further embodiments, the level two node is configured to connect to the second backhaul access point provided by the level one node. In yet further embodiments, responsive to the level one node failing, the level two node is configured to connect to the first backhaul access point and to advertise the backhaul SSID to change roles in the network communications system from a level two node to a level one node.

In some embodiments, the level one node is further configured to advertise a point of sale (POS) SSID to provide a POS access point. In further embodiments, the level two node is further configured to advertise the POS SSID to provide a second POS access point.

In some embodiments, the network communications system further includes an extension node configured to wirelessly communicate with the level zero node and the level one node using a first portion of the first WLAN frequency band, the level one node configured to communicate with the level zero node through the extension node, the level two node configured to wirelessly communicate with the level one node using a second portion of the first WLAN frequency band different from the first portion of the first WLAN frequency band.

According to a number of implementations, the present disclosure relates to a method for provisioning a network communications system. The method includes attaching to a backhaul access point providing a backhaul network connection using a first wireless local area network (WLAN) frequency range, the backhaul network associated with a backhaul service set identifier (SSID), the backhaul access point having a base service set identifier (BSSID) associated therewith. The method also includes obtaining a network address from a network address server having a hardware address. The method also includes comparing the BSSID to the hardware address of the network address server. The method also includes, responsive to determining that the BSSID is the same as the hardware address, assuming a role of a level one node in the network communications system by broadcasting a subscriber SSID that provides a subscriber network connection using a second WLAN frequency range and the backhaul SSID. The method also includes, responsive to determining that the BSSID differs from the hardware address, assuming a role of a level two node in the network communications system by broadcasting the subscriber SSID but not the backhaul SSID.

In some embodiments, the method further includes, responsive to determining that the backhaul SSID is no longer being broadcast by a particular level one node, changing a role from a level two node to a level one node by attaching to the backhaul access point provided by a level zero node and broadcasting the backhaul SSID in addition to the subscriber SSID. In some embodiments, the first WLAN frequency band comprises the 5 GHz frequency band and the second WLAN frequency band comprises the 2.4 GHz frequency band.

In some embodiments, the method further includes dynamically provisioning a first subscriber tunnel to tunnel network traffic from a client coupled to the subscriber SSID. In some embodiments, the method further includes dynamically provisioning a backhaul tunnel to tunnel network traffic from a client coupled to the subscriber SSID, the backhaul tunnel configured to tunnel packets from the level two node to a level zero node of the network communications system.

In some embodiments, the method further includes ceasing advertisement of the subscriber SSID and the backhaul SSID responsive to determining that there is no network connection from the network communications system to an external network. In some embodiments, the method further includes, responsive to determining that a signal strength associated with the BSSID is below a threshold value, attaching to the backhaul network connection using a different backhaul access point having a different BSSID.

For purposes of summarizing the disclosure, certain aspects, advantages and novel features have been described herein. It is to be understood that not necessarily all such advantages may be achieved in accordance with any particular embodiment. Thus, the disclosed embodiments may be carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates an example network communications system that uses a segmented network architecture to provide access to an external network.

FIG. 2 illustrates an example network communications system having a satellite access network to provide access to the Internet, the network including a segmented network architecture with a constellation of nodes.

FIGS. 3A and 3B illustrate a client-side of a network communications system that uses an extension node as part of a constellation of nodes.

FIG. 4 illustrates an example of overlay tunnels implemented on a constellation of nodes to provide connectivity between the nodes.

FIGS. 5A and 5B illustrate dynamic and automatic adjusting of nodes in a constellation of nodes.

FIG. 6 illustrates a flow chart of an example method for automatically provisioning a network communications system having a constellation of nodes and a segmented network architecture.

FIG. 7 illustrates a flow chart of an example method for a self-healing network for a level two node in a constellation of nodes.

### DETAILED DESCRIPTION OF SOME EMBODIMENTS

The headings provided herein, if any, are for convenience only and do not necessarily affect the scope or meaning of the claimed invention.

### Overview

Satellite systems can be used to provide network communication capabilities to users in remote areas or areas where it is challenging or impractical to provide wired connectivity to external networks such as the Internet. In such areas, it may also be difficult to provide cellular service or coverage for similar reasons, making satellite network services advantageous. However, satellite communication equipment may be expensive to install and/or to maintain for certain individual users thereby making it impractical or impossible for these users to take advantage of satellite network communication. Consequently, people living in rural or remote areas may find it difficult or impossible to access external networks such as the Internet. One approach to provide Internet connectivity to such communities is to have a public entity (e.g., a library) or private entity (e.g., a store or Internet cafe) invest in the required infrastructure. However, this may require users to be physically present at the location that provides Internet connectivity, which may be undesirable.

Accordingly, to address these and other issues, described herein are systems and methods for dynamically provisioning network communications systems that use a segmented network architecture to provide wireless access to a satellite network to ultimately provide connectivity to an external network such as the Internet. The disclosed technologies enable dynamic and automated provisioning of network infrastructure that provides wireless access over a geographic area. The disclosed technologies also enable self-healing network nodes, or network nodes that can automatically reconfigure themselves to maintain network connectivity in the case that another network node ceases to function properly. Advantageously, this allows the disclosed network communications systems to be deployed, installed and maintained by relatively unskilled operators or technicians. This may be particularly beneficial in remote communities where there is a lack of skilled network engineers.

The disclosed network communications systems and methods utilize a hierarchy of network nodes that use a segmented network architecture to provide wireless network connectivity. A first segment includes a backbone network segment that is used to communicate network traffic between network nodes. A second segment includes an access network segment that is used to provide an access point to client devices. Network traffic is communicated to the network nodes from the client devices using the access network segment and network traffic is routed along the network nodes (sometimes referred to as a constellation of nodes) using the backbone network segment. The segmented network architecture uses different wireless local area network (WLAN) frequency ranges for the different network segments. For example, the backbone network segment can use a 5 GHz WLAN frequency range and the access network segment can use a 2.4 GHz WLAN frequency range. In addition, some embodiments utilize tunneling to route traffic between the network nodes.

Nodes in the constellation of network nodes are arranged in a hierarchy. A top level node, referred to as a level zero node, provides network controller functionality and communicates with an external network (e.g., to provide access to the Internet). Below the top level node is a level one node that connects to the level zero node to provide access to the external network. The level one node broadcasts one or more service set identifiers (SSIDs) to provide an access point for client devices. The client devices can connect to the access point to thus access the external network. There may be one or more level zero nodes and there may be one or more level one nodes. In addition, there can be one or more level two nodes that each connect to a level one node. The level two nodes serve to expand the coverage range of the constellation. A level two node is identical to a level one node except that it is designated a level two node because it connects to the external network through a level one node. A level two node thus broadcasts one or more SSIDs to provide an access point for client devices. A level two node communicates with a level one node using the backbone network segment. If a level two node is connected to a level one node that fails to provide sufficient network connectivity, the level two node can become a level one node by connecting directly to a level zero node, as described herein. Each level one node and level two node has this functionality, to automatically switch between a level one node and a level two node depending on network connectivity factors.

The disclosed technologies effectively turn a wireless network system (e.g., Wi-Fi system) into a system that behaves more like a cellular system in that a client device can move around within the coverage area provided by the constellation of network nodes and can seamlessly connect to different nodes to maintain network connectivity. The disclosed technologies utilize Wi-Fi protocols to advantageously provide roaming network service to client devices. A challenge is that Wi-Fi protocols are not constructed to efficiently provide roaming capabilities at layer 1 or layer 2 of a network. A typical solution is to use a wireless mesh network to provide similar capabilities. However, a mesh network uses a single frequency band whereas the disclosed technologies use at least two frequency bands in a segmented network architecture to provide network access. In addition, the disclosed technologies use tunneling to route network traffic to the level zero nodes to leverage frequency re-use capabilities of layer 3 of the network. This advantageously increases the available bandwidth for client devices.

The disclosed technologies provide a robust way to deploy networks with little technical knowledge or skill. Once at least one level zero node is established, subsequent network nodes can automatically configure themselves as a level one node (if connected to a level zero node) or a level two node (if connected to a level one node). If wireless signal conditions change, a level one node can become a level two node. Similarly, a level two node can become a level one node responsive to changes in wireless signal strength or condition. The level one node tunnels network traffic from the level two node to the level zero node using the same tunnel used to route network traffic from the level one node to the level zero node. This results in a constellation of network nodes that is capable of dynamic and automatic provisioning, that utilizes frequency re-use, and that uses network tunneling functionalities.

### Network Communications Systems Using a Segmented Network Architecture

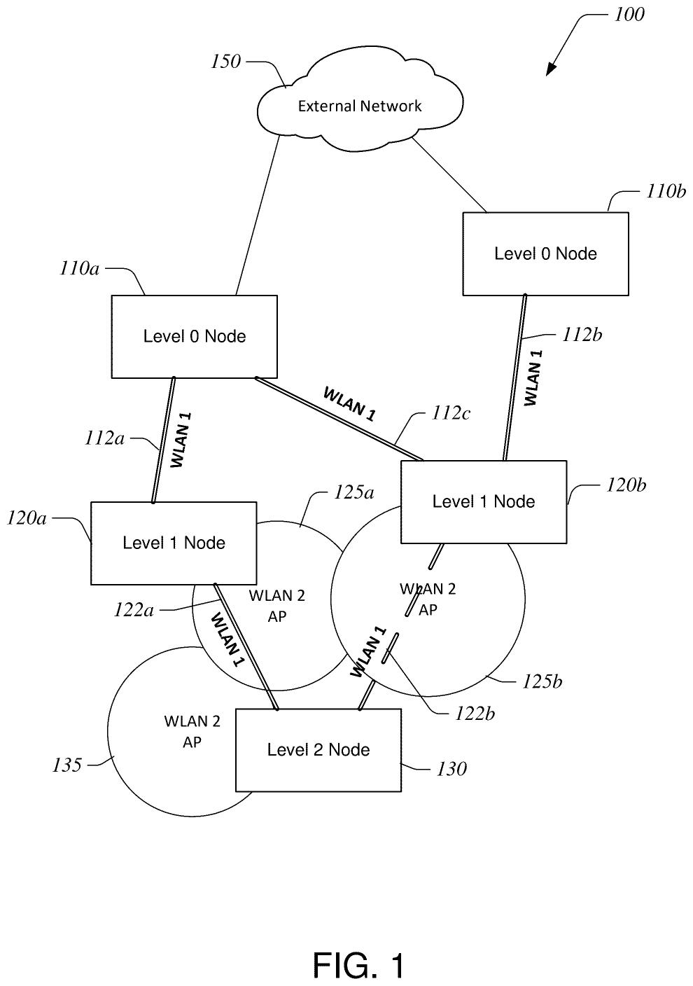

FIG. 1 illustrates an example network communications system 100 that uses a segmented network architecture to provide access to an external network 150. The network communications system includes one or more level zero nodes 110a, 110b, one or more level one nodes 120a, 120b, and one or more level two nodes 130. It should be noted that additional levels of network nodes may be utilized (e.g., level three nodes, level four nodes, etc.). The collection of network nodes 110a, 110b, 120a, 120b, 130 may be referred to as a constellation.

The level zero nodes 110a, 110b communicate with the level one nodes 120a, 120b using a first WLAN frequency range to establish backbone network segments 112a-112c. Similarly, the level one nodes 120a, 120b communicate with the level two node 130 using the first WLAN frequency range to establish backbone network segments 122a, 122b.

The level one nodes 120a, 120b provide wireless access points 125a, 125b using a second WLAN frequency range, the wireless access points 125a, 125b providing access network segments. Similarly, the level two node 130 provides a wireless access point 135 using the second WLAN frequency range, the wireless access point 135 providing an access network segment. Thus, the network communications system provides a segmented network architecture using different WLAN frequency ranges, the segmented network architecture including a backbone network segment that utilizes the first WLAN frequency range and an access network segment that utilizes the second WLAN frequency range.

The level zero nodes 110a, 110b include a network controller and are configured to connect to the external network 150 (e.g., the Internet). In some embodiments, the level zero nodes 110a, 110b connect to the external network 150 through a backhaul network such as a satellite backhaul network, a long-term evolution (LTE) backhaul network, other cellular backhaul network, and/or any suitable communications system that provides access to the external network 150. Consequently, the level zero nodes 110a, 110b include hardware sufficient to connect to the backhaul network, such as a satellite antenna and/or other equipment.

The level zero nodes 110a, 110b act as the root of the network communications system 100 and supports network controller functions. In some embodiments, the level zero nodes 110a, 110b act as tunnel endpoints for network traffic from the level one nodes 120a, 120b and the level two node 130, as described in greater detail herein.

The level zero nodes 110a, 110b can be configured to authenticate users and/or client devices. For example, the level zero nodes 110a, 110b can be configured to offer network access through a captive portal where a user enters a password or other authentication key. The level zero nodes 110a, 110b may also authenticate a MAC address of a client device. The level zero nodes 110a, 110b can then connect the authenticated client device to the external network 150 based on a service plan associated with the client device.

The level one nodes 120a, 120b wirelessly communicate with the level zero nodes 110a, 110b using the first WLAN frequency band. The level one nodes 120a, 120b provide a subscriber access point (AP) 125a, 125b to enable client devices to communicate with the external network 150. The level one nodes 120a, 120b advertise one or more SSIDs. The access points 125a, 125b use the second WLAN frequency band that is different from the first WLAN frequency band.

The level two node 130 wirelessly communicates with the level one nodes 120a, 120b using the first WLAN frequency band. The level two node 130 provides a second subscriber AP 135 to enable client devices to communicate with external network 150. The level two node 130 advertises one or more SSIDs with at least one SSID being the same as an SSID advertised by the level one nodes 120a, 120b. The access point 135 uses the second WLAN frequency band.

The level one nodes 120a, 120b are configured to provide a first subscriber tunnel to tunnel network traffic to the level zero nodes 110a, 110b using the first WLAN frequency band. The level two node 130 provides a second subscriber tunnel to tunnel network traffic to a level zero node 110a, 110b by traversing a level one node 120a, 120b using the first WLAN frequency band.

The level one nodes 120a, 120b include any network node that is one hop away from a level zero node 110a, 110b. Similarly, the level two node 130 includes any network node that is two hops away from a level zero node 110a, 110b. In each case, the level one nodes 120a, 120b and the level two node 130 connects to the level zero nodes 110a, 110b using the first WLAN frequency band (forming the backbone network segment). Similarly, the level one nodes 120a, 120b and the level two node 130 provide access points using the second WLAN frequency band (forming the access network segment).

The backbone network segment includes network communication using the first WLAN frequency band. In some embodiments, the first WLAN frequency range includes 5 GHz frequency bands and may specifically utilize upper bands of the 5 GHz frequency range. The access network segment allows client devices to connect to the level one or level two nodes using the second WLAN frequency band. In some embodiments, the second WLAN frequency band includes bands in the 2.4 GHz frequency range.

In some embodiments, the network communications system 100 can be deployed in the following manner. One or more level zero nodes 110a, 110b can be established, wherein each level zero node 110a, 110b includes a network controller and is configured to connect to a backhaul network (e.g., a satellite or LTE backhaul network) to communicate with the external network 150. The level zero node 110a, 110b advertises a backhaul SSID using the first WLAN frequency range to establish a backhaul access point. This enables network nodes to connect to the level zero node 110a, 110b (to establish the backbone network segments 112a-112c). Once at least one level zero node 110a, 110b is established, one or more level one nodes 120a, 120b can be deployed. A level one node 110a, 110b is configured to automatically search for the backbone network segment provided by a level zero node (e.g., the backhaul SSID). Once found, a level one node 120a, 120b configures itself as a level one node if the backbone network segment 112a-112c is being provided directly by a level zero node 110a, 110b. As part of this process, the level one node 120a, 120b also advertises the backhaul SSID to add the backbone network segments 122a, 122b and advertises one or more access SSIDs using the second WLAN frequency band to establish the access network segments 125a, 125b.

Additional network nodes can be deployed, and each additional network node can configure itself as a level one node or a level two node, depending on the signal strength and/or radio stability of the node to which it is connected. For example, if the strongest signal is coming from a level one node, then a newly provisioned node will configure itself as a level two node. A level two node 130 is configured to advertise one or more SSIDs using the second WLAN frequency range that form the access network segment 135. Similarly, if the strongest signal is coming from a level zero node, then a newly provisioned node will configure itself as a level one node. In other words, a newly provisioned node in the constellation attaches to the access point advertising the backhaul SSID that has the most favorable signal conditions. Furthermore, if a level one node drops out (e.g., the signal strength dips below a threshold level), a level two node that was connected to the level one node can find another level one node to connect to or it can reconfigure itself as a level one node and connect directly to a level zero node. In other words, responsive to a level one node failing, a level two node is configured to connect to the backhaul access point provided by a level zero node and to advertise the backhaul SSID to change roles in the network communications system from a level two node to a level one node.

In some embodiments, a newly provisioned node goes through a DHCP process to obtain a network address. During this process, the node compares the BSSID providing the backhaul SSID and the MAC address of the DHCP server providing the network address. If the addresses are the same, meaning that the BSSID to which it is connected is a level zero node, the newly provisioned node configures itself as a level one node. Once connected to the level zero node, the newly provisioned level one node then broadcasts one or more SSIDs using the second WLAN frequency range. In some embodiments, the SSIDs include a subscriber SSID and a point-of-sale (POS) SSID. The level one node also advertises the backhaul SSID using the first WLAN frequency range. If the addresses are different, meaning that the BSSID to which it is connected is not a level zero node, the newly provisioned node configures itself as a level two node. Once connected to the level one node, the newly provisioned level two node then broadcasts the one or more SSIDs using the second WLAN frequency range. In some embodiments, the SSIDs include the subscriber SSID and the POS SSID. In certain embodiments, the level two node does not advertise the backhaul SSID. In implementations that include level three or higher nodes, the level two node can be configured to advertise the backhaul SSID. In such implementations, the highest-level node is configured to not advertise the backhaul SSID. In such implementations, each node in the constellation is configured to advertise the SSIDs that make up the access network segment (e.g., the subscriber SSID and/or the POS SSID). Each advertised SSID thus provides a corresponding access point (e.g., a subscriber access point, a POS access point, and/or a backhaul access point).

Network traffic is tunneled back to the level zero node either directly from a level one node or from a level two node through a level one node. This allows a client device to appear as though it is directly connected to a level zero node.

The disclosed network architecture differs from a typical mesh Wi-Fi network. The disclosed architectures re-use the second WLAN frequency bands (e.g., the 2.4 GHz frequency bands) to provide client device network services and use the first WLAN frequency bands (e.g., the 5 GHz frequency bands) to provide a backhaul network. This is advantageous due at least in part to radios that transmit and receive the first WLAN frequency bands typically being more capable than those for the second WLAN frequency bands. In addition, typical mesh networks predetermine frequencies that are to be used because the entire network uses the same frequency. Here, different frequency bands are used for different purposes, e.g., to provide a segmented network architecture. The disclosed network architectures are generally more robust than typical mesh networks in that the disclosed network architectures can be deployed in multi-vendor environments in an uncontrolled network ecosystem because it can use a variety of frequencies and utilizes a segmented network architecture. Advantageously, the disclosed network architectures can be deployed using off-the-shelf hardware components and may use open source or other widely available networking software. Because the nodes are designed to configure themselves to adopt an appropriate role in the network constellation, little technical skill or knowledge is required to deploy the network communications system. In addition, the network architecture can be used with a variety of backhaul networks, including satellite networks to cellular networks.

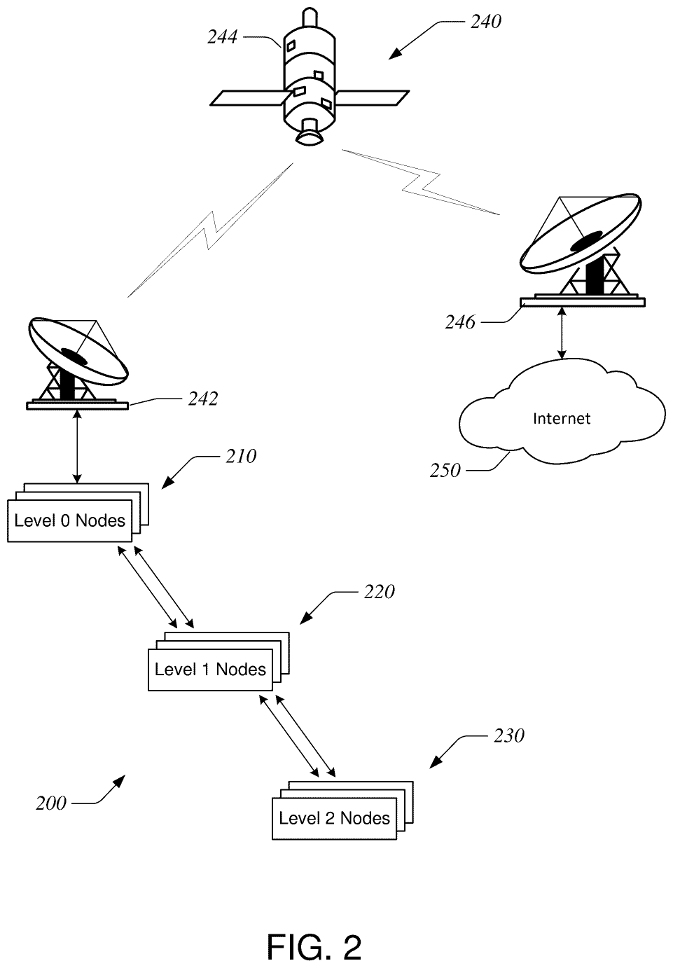

FIG. 2 illustrates an example network communications system 200 having a satellite access network 240 to provide access to the Internet 250, the network including a segmented network architecture with a constellation of nodes 210, 220, 230. The network communications system 200 is similar to the network communications system 100 of FIG. 1, except that the backhaul network is specified as being a satellite access network 240 and the external network 150 is specified as being the Internet 250. The satellite access network 240 can include one or more satellites 244, one or more satellite user terminals, gateway terminals, network operations centers (NOCs), satellite and gateway terminal command centers, and/or the like. In some embodiments, the satellite network 240 includes one or more satellites 244 in a geosynchronous orbit, in a medium earth orbit, and/or in a low earth orbit.

One or more client devices are configured to communicate with the Internet by connecting to a level one node 220 or a level two node 230. The level zero nodes 210 are configured to route data received from the client devices (through level one nodes 220 and/or level two nodes 230) to the satellite network 240 (via a client satellite transceiver 242). The satellite network 240 includes a forward link for sending information from a gateway satellite transceiver 246 to the level zero nodes 210, and a return link for sending information from the level zero nodes 210 to the gateway satellite transceiver 246. The forward link includes a transmission path from the gateway satellite transceiver 246, through a satellite 244 via a satellite uplink channel, to the client satellite transceiver 242 via a satellite downlink channel, and to the level zero nodes 210. The return link includes a transmission path from the client satellite transceiver 242, to the satellite 244 via the satellite uplink channel, to the gateway satellite transceiver 246 via the satellite downlink channel. Each transmission channel may utilize multiple satellites and transceivers.

The satellite 244 is configured to receive and transmit signals. The satellite 244 may receive the forward uplink signals from the gateway satellite transceiver 246 and transmit one or more corresponding forward downlink signals to one or more client device through the level zero nodes 210 via the client satellite transceiver 242. The satellite 244 may also receive one or more return uplink signals from one or more client devices through the level zero nodes 210 and transmit corresponding return downlink signals to the gateway satellite transceiver 246.

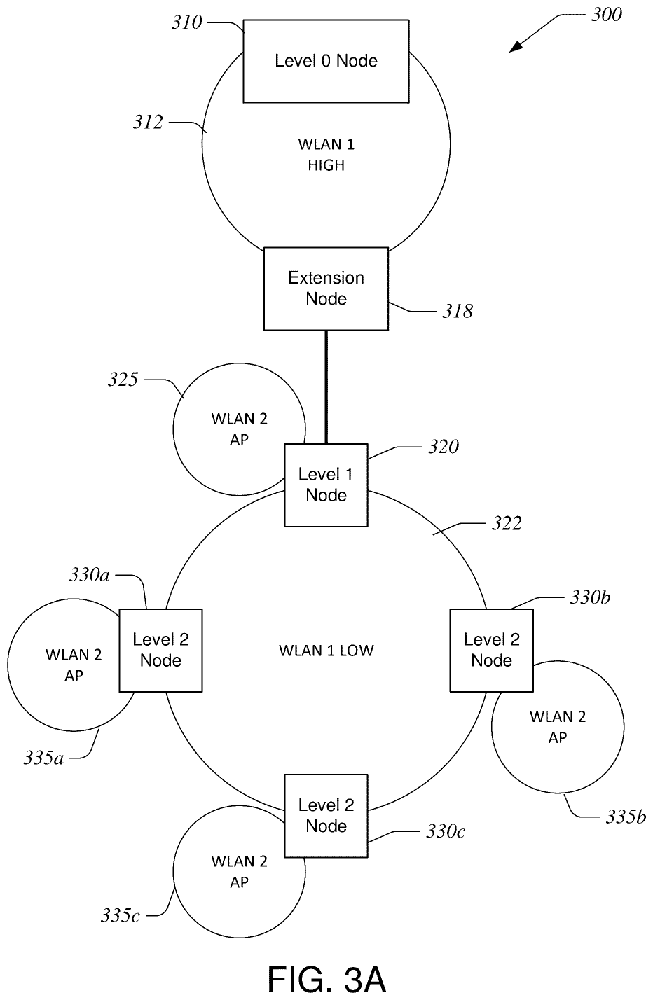

FIG. 3A illustrates a client-side of a network communications system 300 that uses an extension node 318 as part of a constellation of nodes 310, 320, 330a-c. The network communications system 300 is similar to the network communications system 100 of FIG. 1 with the addition of the extension node 318 to extend the coverage range of the network communications system 300. The extension node 318 is configured to wirelessly communicate with the level zero node 310 and the level one node 320 using a first portion of the first WLAN frequency band (WLAN 1 HIGH), the level one node 320 configured to communicate with the level zero node 310 through the extension node 318. Level two nodes 330a-c are configured to wirelessly communicate with the level one node 320 using a second portion of the first WLAN frequency band (WLAN 2 LOW) different from the first portion of the first WLAN frequency band. In some embodiments, the extension node 318 includes a higher gain antenna (e.g., a 60-degree antenna). The extension node 318 can be configured to directionally transmit a signal to a targeted region to extend the coverage of the network communications system 300 in a targeted way. The extension node 318 is configured to connect to the backbone network segment 312 that operates in a different region of the first WLAN frequency range from the backbone network segment 322 to provide a specific extension access point. Another difference relative to the network communications system 100 is that the network communications system 300 uses a portion of the first WLAN frequency range to provide the backbone network segment 322 and a different portion of the first WLAN frequency range to provide the backbone network segment 312.

In the network communications system 300, the extension node 318 connects to the level zero node 310 using the backbone network segment 312. However, the extension node 318 is not necessarily configured to act as a level one node (e.g., it does not advertise SSIDs corresponding to the access network segment as described herein). The level one node 320 is configured to connect to the extension node 318 and to configure itself as a level one node even though it does not directly connect to the level zero node 310. The level one node 320 advertises one or more SSIDs to provide an access network segment 325. Thus, the network communications system 300 differs from the network communications system 100 in that the level one node 320 configures itself as a level one node if it connects to the backhaul SSID advertised by a level zero node or by an extension node 318.

The level two nodes 330a-330c operate as described herein with reference to FIG. 1 in that they configure themselves as level two nodes if they connect to the backhaul SSID 322 advertised by a level one node. Each level two node 330a-c also advertises SSIDs corresponding to the access network segment 335a-335c, as described herein. If a level two node attaches to the extension node 318 rather than a level one node 320 (e.g., because the level one node powers off or fails to provide a sufficient signal), then the level two node will reconfigure itself as a level one node, as described herein.

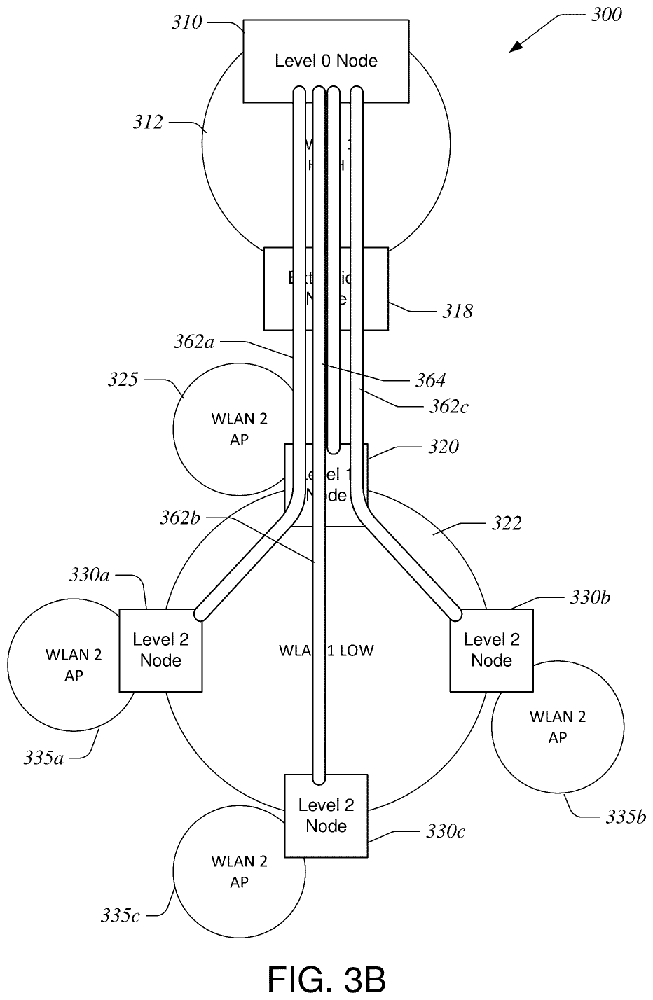

FIG. 3B illustrates the network communications system 300 of FIG. 3A with examples of overlay tunnels 362, 364 implemented to provide connectivity between the level zero node 310, the level one node 320, and the level two nodes 330a-330c. Network traffic is tunneled from a level two node 330a-c to the level zero node 310 through the level one node 320 and the extension node 318 using a corresponding backhaul tunnel 362a-c. Similarly, network traffic is tunneled from the level one node 320 to the level zero node 310 through the extension node 318 using the tunnel 364. Further examples of overlay tunnels are provided herein with respect to the description of FIG. 4.

FIG. 4 illustrates an example of overlay tunnels implemented on a constellation of nodes 410, 420, 430 to provide connectivity between the nodes. Network traffic is tunneled from the level two node 430 to the level zero node 410 through the level one node 420 using a backhaul tunnel 462. Network traffic can be tunneled from the level one node 420 to the level zero node 410 using the tunnel 464. Tunneling includes the process of encapsulating packets within other packets. Tunneling can include any suitable encapsulation technology such as generic routing encapsulation (GRE). The nodes can act as endpoints of the tunnels.

The tunnels 462, 464 each are configured to terminate at the level zero node 410. The tunnel 462 traverses the level one node 420. In some embodiments, the network address used for the tunnels 462, 464 can be configured to indicate what kind of tunnel it is. This signaling technique can be used to implement tunneling protocols for a layer 2 tunnel.

Tunnels can be advantageous because they allow users to roam across the constellation of nodes without requiring re-authentication. For example, tunneling allows for layer 2 access to be maintained from the edges of the network (e.g., from level two nodes to level zero nodes). This enables session management protocols to be used that associate authentication with MAC addresses to manage client sessions. The controller on the level zero node uses MAC addresses to manage sessions and stores information to enable a user (or a client device) to enter and leave the network without requiring re-authentication each time this happens. In some embodiments, a remote authentication dial-in user service (RADIUS) protocol can be used to provide centralized authentication, authorization, and accounting management for users that connect to the network communications system. The backhaul network are configured to use network address so that each hop along the constellation of nodes is routed and maintains layer 2 headers.

In some embodiments, each SSID advertised by a node can have an associated tunnel. A subscriber SSID tunnel can be configured to tunnel client layer 2 traffic to the level zero node 410 from either a level one node 420 or a level two node 430. Similarly, a POS SSID tunnel can be configured to tunnel POS layer 2 traffic to the level zero node 410 from either a level one node 420 or a level two node 430. Likewise, a backhaul tunnel 462 can be configured to tunnel layer 2 traffic to the level zero node 410 from the level two node 430 through the level one node 420. In some embodiments, the network communications system does not use typical network routing protocols, but rather each device is provided a network address from a DHCP pool that has a default gateway on the controller of the level zero node 410. The level two node 430 connects to the backhaul SSID advertised by the level one node 420 and that access point is attached to a layer 2 tunnel that lands on a bridge on the controller of the level zero node 410. This allows DHCP messages to be seamlessly transmitted to and from the level two node 430 even though the level two node 430 is not directly attached to the level zero node 410.

In some embodiments, the level one node 420 is configured to provide a first subscriber tunnel 464 to tunnel network traffic to the level zero node using the first WLAN frequency band and the level two node 430 is configured to provide a second subscriber tunnel 462 to tunnel network traffic to the level zero node 410 by traversing the level one node 420 using the first WLAN frequency band. In some embodiments, the first subscriber tunnel 464 and the second subscriber tunnel 462 are provisioned dynamically.

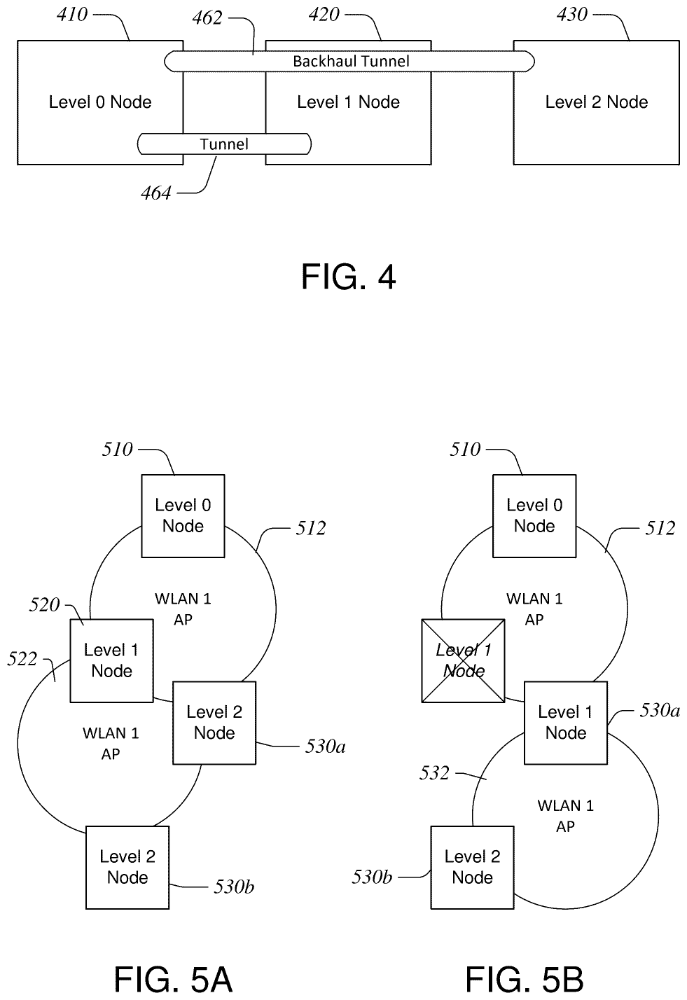

FIGS. 5A and 5B illustrate dynamic and automatic adjusting of nodes in a constellation of nodes. As described herein, responsive to a level one node 520 failing, a level two node 530a or 530b is configured to connect to the first backhaul access point 512 and to advertise the backhaul SSID 532 to change roles in a network communications system from a level two node to a level one node.

During operation, if a level one node 520 fails and a level two node 530a or 530b can detect another level one node or a level zero node 510, the level two node 530a or 530b connects to the detected BSSID (with most favorable RF conditions) and establishes connectivity. If the level two node 530a or 530b connects to the level zero node 510 rather than another level one node, the level two node 530a or 530b changes roles to a level one node. This is illustrated in FIG. 5B with the level two node 530a changing roles to a level 1 node 530a. The level two node 530b remains a level two node with the difference being that the level two node 530b is now connected to the new level one node 530b through the newly advertised backhaul access point 532. Once its role changes, the new level one node 530a advertises the backhaul SSID 532 as part of its new role as a level one node. As a level two node, as illustrated in FIG. 5A, the level two node 530a does not advertise the backhaul SSID 532 but rather the level one node 520 advertises the backhaul SSID 522. This can be referred to as a self-healing constellation of network nodes meaning that in response to a failure of a node, the constellation of nodes can be automatically fixed or adjusted to maintain functionality.

In some embodiments, if a client device cannot use the Internet reliably, the client device should not attach to the network at all. This can be managed by establishing connectivity rules within the network communications system. For example, if an uplink to the backhaul network (e.g., a satellite network) is down, the level zero node 510 can cease advertising the backhaul SSID. In response, the level one node 520 detects that there is no backhaul SSID from the level zero node 510 and can search for another level zero node. If none are found, the level one node 520 can cease advertising the backhaul SSID 522 and any other SSIDs that form the access network segment. Likewise, if the level two nodes 530a, 530b detect that there is no backhaul SSID 522 from the level one node 520, they can search for another level one node. If none is found and they cannot find a level zero node, the level two nodes 530a, 530b can cease advertising any SSIDs that form the access network segment. As a result, rather than providing intermittent and spotty network connectivity that may reduce customer satisfaction, no SSIDs are advertised to indicate to the client that the network is down. This may be preferable to indicating a possibility of network access by advertising an SSID when network access is impossible (e.g., due to the backhaul network being down). In some embodiments, a similar procedure is implemented when a signal from a node is below a predetermined threshold. This may be advantageous because it reduces the possibility of a poor user experience with spotty or poor wireless connections.

### Dynamically Provisioning and Managing Network Communications

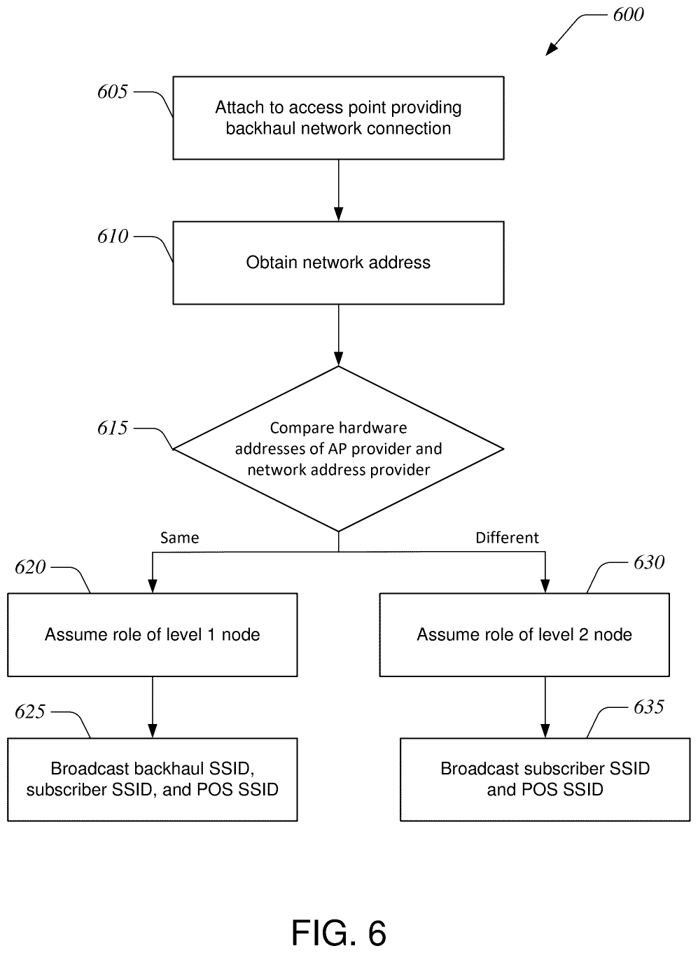

FIG. 6 illustrates a flow chart of an example method 600 for automatically provisioning a network communications system having a constellation of nodes and a segmented network architecture. In block 605, a network node attaches to a backhaul access point providing a backhaul network connection using a first wireless local area network (WLAN) frequency range, the backhaul network associated with a backhaul service set identifier (SSID), the backhaul access point having a base service set identifier (BSSID) associated therewith. In some embodiments, the first WLAN frequency band comprises the 5 GHz frequency band and the second WLAN frequency band comprises the 2.4 GHz frequency band.

In block 610, the network node obtains a network address from a network address server having a hardware address. In block 615, the network node compares the BSSID to the hardware address of the network address server. In block 620, responsive to determining that the BSSID is the same as the hardware address, the network node assumes a role of a level one node in the network communications system. In block 625, the network node broadcasts a subscriber SSID that provides a subscriber network connection using a second WLAN frequency range and the backhaul SSID. In some embodiments, the network node also broadcasts a POS SSID.

In block 630, responsive to determining that the BSSID differs from the hardware address, the network node assumes a role of a level two node in the network communications system. In block 635, the network node broadcasts the subscriber SSID but not the backhaul SSID. In some embodiments, the network node also broadcasts a POS SSID.

In some embodiments, the method 600 also includes dynamically provisioning a first subscriber tunnel to network traffic from a client coupled to the subscriber SSID. In some embodiments, the method 600 also includes dynamically provisioning a backhaul tunnel to network traffic from a client coupled to the subscriber SSID, the backhaul tunnel configured to tunnel packets from the level two node to a level zero node of the network communications system.

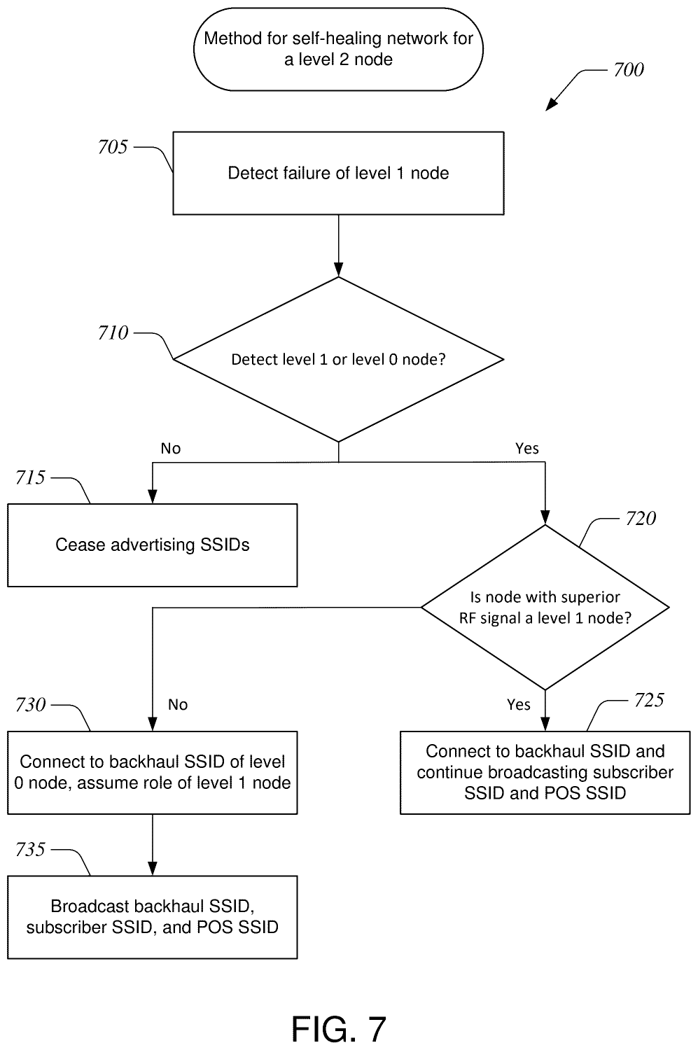

FIG. 7 illustrates a flow chart of an example method 700 for a self-healing network for a level two node in a constellation of nodes. In some embodiments, responsive to a level one node failing in a network communications system, a level two node is configured to connect to a backhaul access point and to advertise the backhaul SSID to change roles in the network communications system from a level two node to a level one node.

In block 705, the level two node detects the failure of a level one node. In block 710, the level two node tries to detect another level one node or a level zero node. In block 715, responsive to not detecting any other nodes, the level two node ceases advertising SSIDs. In some embodiments, the level two node ceases advertisement of the subscriber SSID and the backhaul SSID responsive to determining that there is no network connection from the network communications system to an external network.

In block 720, responsive to detecting another network node, the level two node determines the type of node that is providing the superior wireless (e.g., radio frequency (RF)) signal. In block 725, responsive to determining that the superior signal is provided by a level one node, the level two node connects to the backhaul SSID and continues broadcasting a subscriber SSID and a POS SSID. In some embodiments, responsive to determining that a signal strength associated with the BSSID is below a threshold value, the level two node attaches to the backhaul network connection using a different backhaul access point having a different BSSID.

In block 730, responsive to determining that the node with the superior signal is a level zero node, the level two node connects to the backhaul SSID of the level zero node. The level two node assumes the role of a level one node. In block 735, the level two node broadcasts the backhaul SSID, the subscriber SSID, and the POS SSID.

### Additional Embodiments and Terminology

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the scope of the disclosure. The accompanying claims and their equivalents are intended to cover such forms or modifications as would fall within the scope of the disclosure.

1. A network communications system (100, 200, 300) comprising:
a level zero node (110a, 110b, 210, 310, 410, 510) comprising a network controller and configured to connect to an external network (150, 250);
a level one node (120a, 120b, 220, 320, 420, 520) configured to wirelessly communicate with the level zero node (110a, 110b, 210, 310, 410, 510) using a first wireless local area network (WLAN) frequency band, to provide a first subscriber access point (125a, 125b, 325) to enable one or more client devices to communicate with the external network (150, 250), and to advertise a subscriber service set identifier (SSID) for connecting to the first subscriber access point (125a, 125b, 325), the first subscriber access point (125a, 125b, 135, 325, 335a-c) using a second WLAN frequency band different from the first WLAN frequency band; and
a level two node (130, 230, 330a-c, 430, 530a, 530b) configured to wirelessly communicate with the level one node (120a, 120b, 220, 320, 420, 520) using the first WLAN frequency band, to provide a second subscriber access point (135, 335a-c) to enable one or more client devices to communicate with the external network (150, 250), and to advertise the subscriber SSID for connecting to the second subscriber access point (135, 335a-c), the second subscriber access point (135, 335a-c) using the second WLAN frequency band,
wherein the level one node (120a, 120b, 220, 320, 420, 520) is configured to provide a first subscriber tunnel (464) to tunnel network traffic to the level zero node (110a, 110b, 210, 310, 410, 510) using the first WLAN frequency band,
wherein the level two node (130, 230, 330a-c, 430, 530a, 530b) is configured to provide a second subscriber tunnel (462) to tunnel network traffic to the level zero node (110a, 110b, 210, 310, 410, 510) by traversing the level one node (120a, 120b, 220, 320, 420, 520) using the first WLAN frequency band,
wherein the first WLAN frequency band comprises the 5 GHz frequency band and the second WLAN frequency band comprises the 2.4 GHz frequency band.

2. (canceled)

3. The network communications system (100, 200, 300) of claim 1, wherein the first subscriber tunnel (464) and the second subscriber tunnel (462) are provisioned dynamically.

4. The network communications system (100, 200, 300) of claim 1, wherein the level zero node (110a, 110b, 210, 310, 410, 510) is configured to communicate with a satellite network (240) to connect to the external network (150, 250).

5. The network communications system (100, 200, 300) of claim 1, wherein the external network (150, 250) comprises the Internet.

6. (canceled)

7. The network communications system (100, 200, 300) of claim 1, wherein the level zero node (110a, 110b, 210, 310, 410, 510) is further configured to advertise a backhaul SSID to provide a first backhaul access point (512) that uses the first WLAN frequency band.

8. The network communications system (100, 200, 300) of claim 7, wherein the level one node (120a, 120b, 220, 320, 420, 520) is configured to connect to the first backhaul access point (512) provided by the level zero node (110a, 110b, 210, 310, 410, 510) and to advertise the backhaul SSID to provide a second backhaul access point (532) that uses the first WLAN frequency band.

9. The network communications system (100, 200, 300) of claim 8, wherein the level two node (130, 230, 330a-c, 430, 530a, 530b) is configured to connect to the second backhaul access point (532) provided by the level one node (120a, 120b, 220, 320, 420, 520).

10. The network communications system (100, 200, 300) of claim 9, wherein, responsive to the level one node (120a, 120b, 220, 320, 420, 520) failing, the level two node (130, 230, 330a-c, 430, 530a, 530b) is configured to connect to the first backhaul access point (512) and to advertise the backhaul SSID to change roles in the network communications system (100, 200, 300) from a level two node (130, 230, 330a-c, 430, 530a, 530b) to a level one node (120a, 120b, 220, 320, 420, 520).

11. The network communications system (100, 200, 300) of claim 1, wherein the level one node (120a, 120b, 220, 320, 420, 520) is further configured to advertise a point of sale (POS) SSID to provide a POS access point.

12. The network communications system (100, 200, 300) of claim 11, wherein the level two node (130, 230, 330a-c, 430, 530a, 530b) is further configured to advertise the POS SSID to provide a second POS access point.

13. The network communications system (100, 200, 300) of claim 1 further comprising an extension node configured to wirelessly communicate with the level zero node (110a, 110b, 210, 310, 410, 510) and the level one node (120a, 120b, 220, 320, 420, 520) using a first portion of the first WLAN frequency band, the level one node (120a, 120b, 220, 320, 420, 520) configured to communicate with the level zero node (110a, 110b, 210, 310, 410, 510) through the extension node, the level two node (130, 230, 330a-c, 430, 530a, 530b) configured to wirelessly communicate with the level one node (120a, 120b, 220, 320, 420, 520) using a second portion of the first WLAN frequency band different from the first portion of the first WLAN frequency band.

14. A method for provisioning a network communications system (100, 200, 300), the method comprising:
attaching, by a network node (110a, 110b, 120a, 120b, 130, 210, 220, 230, 310, 320, 330a-c, 410, 420, 430, 510, 520, 530a, 530b), to a backhaul access point (512, 522, 532) providing a backhaul network connection using a first wireless local area network (WLAN) frequency range, the backhaul network associated with a backhaul service set identifier (SSID), the backhaul access point (512, 522, 532) having a base service set identifier (BSSID) associated therewith, the BSSID being a hardware address of the backhaul access point (512, 522, 532);
obtaining, by the network node (110a, 110b, 120a, 120b, 130, 210, 220, 230, 310, 320, 330a-c, 410, 420, 430, 510, 520, 530a, 530b), a network address from a network address server and a hardware address of the network address server;
comparing, by the network node (110a, 110b, 120a, 120b, 130, 210, 220, 230, 310, 320, 330a-c, 410, 420, 430, 510, 520, 530a, 530b), the BSSID to the hardware address of the network address server;
responsive to determining that the BSSID is the same as the hardware address, assuming, by the network node (110a, 110b, 120a, 120b, 130, 210, 220, 230, 310, 320, 330a-c, 410, 420, 430, 510, 520, 530a, 530b), a role of a level one node (120a, 120b, 220, 320, 420, 520) in the network communications system (100, 200, 300) by broadcasting a subscriber SSID that provides a subscriber network connection using a second WLAN frequency range and the backhaul SSID; and
responsive to determining that the BSSID differs from the hardware address, assuming, by the network node (110a, 110b, 120a, 120b, 130, 210, 220, 230, 310, 320, 330a-c, 410, 420, 430, 510, 520, 530a, 530b), a role of a level two node (130, 230, 330a-c, 430, 530a, 530b) in the network communications (100, 200, 300) system by broadcasting the subscriber SSID but not the backhaul SSID.

15. The method of claim 14 further comprising, responsive to determining that the backhaul SSID is no longer being broadcast by a particular level one node (120a, 120b, 220, 320, 420, 520), changing, by the network node (110a, 110b, 120a, 120b, 130, 210, 220, 230, 310, 320, 330a-c, 410, 420, 430, 510, 520, 530a, 530b), a role from a level two node (130, 230, 330a-c, 430, 530a, 530b) to a level one node (120a, 120b, 220, 320, 420, 520) by attaching to the backhaul access point (512, 522, 532) provided by a level zero node (110a, 110b, 210, 310, 410, 510) and broadcasting the backhaul SSID in addition to the subscriber SSID.

16. The method of claim 14, wherein the first WLAN frequency band comprises the 5 GHz frequency band and the second WLAN frequency band comprises the 2.4 GHz frequency band.

17. The method of claim 14 further comprising dynamically provisioning, by the network node (110a, 110b, 120a, 120b, 130, 210, 220, 230, 310, 320, 330a-c, 410, 420, 430, 510, 520, 530a, 530b), a first subscriber tunnel (464) to tunnel network traffic from a client coupled to the subscriber SSID.

18. The method of claim 14 further comprising dynamically provisioning, by the network node (110a, 110b, 120a, 120b, 130, 210, 220, 230, 310, 320, 330a-c, 410, 420, 430, 510, 520, 530a, 530b), a backhaul tunnel (462, 464) to tunnel network traffic from a client coupled to the subscriber SSID, the backhaul tunnel (462, 464) configured to tunnel packets from the level two node (130, 230, 330a-c, 430, 530a, 530b) to a level zero node (110a, 110b, 210, 310, 410, 510) of the network communications system (100, 200, 300).

19. The method of claim 14 further comprising ceasing, by the network node (110a, 110b, 120a, 120b, 130, 210, 220, 230, 310, 320, 330a-c, 410, 420, 430, 510, 520, 530a, 530b), advertisement of the subscriber SSID and the backhaul SSID responsive to determining that there is no network connection from the network communications system (100, 200, 300) to an external network (150, 250).

20. The method of claim 14 further comprising, responsive to determining that a signal strength associated with the BSSID is below a threshold value, attaching, by the network node (110a, 110b, 120a, 120b, 130, 210, 220, 230, 310, 320, 330a-c, 410, 420, 430, 510, 520, 530a, 530b), to the backhaul network connection using a different backhaul access point having a different BSSID.
